(19) United States
(12) Patent Application Publication
(10) Pub. No.: US 2012/0186732 A1
(43) Pub. Date: Jul. 26, 2012

(54) Pipe Coating Apparatus and Method

(75) Inventors: Ian Sprague, Sherwood Park (CA); Charles Frederick McKay, Edmonton (CA)

(73) Assignee: CRC-EVANS CANADA LTD., Edmonton (CA)

(21) Appl. No.: 13/012,546

(22) Filed: Jan. 24, 2011

(51) Int. Cl. B29C 63/10

(52) U.S. Cl. 156/188; 156/187; 156/429

(57) ABSTRACT

Pipe coating apparatus including a concrete applicator station, a pipe conveyor adapted to longitudinally advance and axially rotate a section of pipe alongside the concrete applicator station, and an overhead container adapted to receive and dispense a supply of mixed concrete to the concrete applicator station. The concrete applicator station includes one or a plurality of concrete applicators, each concrete applicator being adapted to extrude a layer of concrete onto a carrier band, and to horizontally convey the layer of concrete on the carrier band to the underside of the pipe to form a continuous helical wrap of the layer of concrete on the carrier band around the pipe as the pipe is advanced and rotated, and in the case of the plurality of concrete applicators, each concrete applicator being laterally spaced one from another alongside the pipe such that the helical wrap from a first of the plurality of concrete applicators is successively covered by the helical wrap from each of an adjacent concrete applicator of the plurality of concrete applicators.

### FIELD OF THE INVENTION

This invention relates to a pipe coating apparatus and a method of coating a pipe with a concrete weighting coating.

### BACKGROUND

Pipelines transporting liquid or gaseous materials often extend through areas where the pipeline needs to be weighted to avoid having the pipeline being lifted or heaved by buoyant forces or frost. Such areas include, for example, underwater, marsh, muskeg, and other unconsolidated environments. A trench is typically formed, the pipeline is installed in the trench, and sections of the pipeline are anchored, coated, or weighted with concrete, clamp on weights, or bag weights filled with weighting fill material. The weighted or anchored pipeline must thereafter resist hydrostatic forces of flooding, or freeze-thaw cycles.

Early pipeline weights included simple or complex concrete or concrete-containing devices which could be placed on or strapped around the pipeline, see for instance Canadian Patent 2,158,801 issued Jul. 14, 1998 to Key-May Industries Ltd. More recently, saddle-bag type weights made from woven or non-woven geotextile bags filled with ballast, have been suspended from the pipeline along its length. In many pipeline installations, there is a need for continuous concrete coatings to be applied to lengths of the pipeline to weight the pipeline and/or to provide a thin protective shield to the pipeline, ex. a rock shield.

Concrete coatings to weight pipelines generally fall into one of four categories—forming, guniting, impingement, and extrusion. Forming involves applying concrete within “forms” surrounding the pipeline. It is a slow, labour intensive process suitable for short lengths of pipe. Guniting is a process in which concrete is sprayed onto the pipe under pressure. Like forming, this process is labour intensive and of limited suitability for longer pipeline lengths. Impingement coating is a downward or horizontal, high velocity application system using drawn or cage type reinforcing wire mesh held by spacers on the pipe while the concrete is being applied. Impingement is not permitted in some countries, particularly where it may harm the exterior corrosion coating present on most pipeline surfaces. Extrusion is a process in which concrete is effectively rolled onto the pipe from an applicator as the pipe is rotated. Usually a heavy outer wrap such as polyethylene serves as a carrier to apply the extruded concrete. Reinforcing wire mesh is often used in the process to strengthen the concrete. Extrusion coatings of concrete have generally been restricted in the thicknesses of coatings that can be applied, with single layers of a few inches often being the limit. Attempts to apply simultaneous multiple layers of concrete with increased thickness have been made, although most have involved overly complex extrusion applicators and edge shapers, and/or have produced layers prone to unevenness or cracking.

Presently most concrete coating of pipe is done manually using hand built forms, or mechanically at large stationary or hard to move installations. The use of hand built forms allows concrete coating to take place at the pipeline installation site but requires large amounts of time and labour to construct and disassemble the forms. Mechanically coating pipe is faster but usually has a high transportation cost due to its weight and the distance it must be moved to the pipeline installation site from the location of the coating machinery.

U.S. Pat. No. 1,979,656 to Whitman shows an early extrusion applicator for applying a mortar to a rotating pipe. A tape is loaded with mortar and spirally wound onto the rotating pipe. A plate moves the applicator along beside the pipe to coat a short section of the pipe. U.S. Pat. No. 3,740,291 to Mallard shows an applicator to apply a coating from above the pipe, while feeding a wire mesh into the setting concrete in a manner such that the reinforcing wire is trapped within the coating. While the reinforcing mesh can increase the thickness and strength of the coating, control over the mesh embedding within the coating can be problematic. Furthermore, the applicator in Mallard includes complex forms surrounding the pipe, making it ill suited to coat pipes of differing diameters.

A number of pipe wrapping technologies incorporate an impermeable wrap or polywrap as the outer layer, often to weatherproof the wrapped pipe product. U.S. Pat. No. 4,472,335 to Meyer et al. describes a system to coat a pipe with a fibre-reinforced concrete (FRC). The FRC is fed onto a carrier band through a discharge slot located alongside the rotating pipe. The carrier band is tensioned to densify the coating being applied to the pipe. FRC coatings are typically very thin so are useful for the purpose of protecting the pipeline against damage during pipeline installation, such as from rocks. The carrier band of the Meyer et al. patent is described as being an impermeable film. Impermeable carrier bands can be problematic for the underlying anti-corrosive coatings found on most pipelines. U.S. Pat. No. 4,006,049 to Gardner describes a extrusion applicator mounted on a conveyor belt to feed an extruded layer of concrete on a wire mesh carrier to the underside of a rotating pipe. A complicated second belt system is described, riding above the first belt to feed an outer polymeric wrapping for the concrete coated pipe. This polywrap outer wrapping is for weather proofing purposes, and is cumbersome since it must be removed before pipeline installation to avoid interfering with the cathodic protection systems (low level electrical currents) used to protect the pipe from corrosion. The polywrap is difficult to remove as the edges are typically set into the concrete.

Attempts at forming multiple layers of weighting concrete to pipeline sections have to date been problematic, involving complicated methods and equipment to address overlap difficulties at the edges of the layers. This has limited the thickness of concrete layers, and has thus limited the weighting that can be achieved with multiple concrete layers. U.S. Pat. No. 4,333,783 to Gardner describes a device to feed multiple overlapping layers of reinforcing wire mesh in side-by-side slots through an extrusion hopper onto a single conveyor belt. The patent describes a complex system of knife cutters to cut the edges of the layers to allow adjacent wire mesh strips to overlap throughout the coating. U.S. Pat. No. 4,544,426 to Stockman describes a device for delivering multiple layers of extruded concrete in a thick stack to a rotating pipe. The device includes a complicated system of notching conveyors and discs so that the layers can overlap at the seams. U.S. Pat. Nos. 5,261,995 and 5,302,221 to Golden describes a method of applying multiple layers of reinforced concrete, successively superimposed on each other, onto a rotating pipeline. Hereagain, although attempting to provide multiple layers, the layers are stacked and a complicated system is needed to vary successive layer widths and to drive edge trimming rollers. U.S. Pat. Nos. 5,667,623 and 5,888,339 to Hanson are similar to the Gardner patents in that they apply an extruded layer of reinforced concrete and a layer of polyfilm (or polywrap), both layers being simultaneously wrapped onto the pipe in a single pass. The pipe is rotated within a complicated series of belts that apply the coating and also rotate the pipe. The poly film must thereafter be removed from the concrete layer as noted above to avoid interfering with the cathodic protection systems used for the pipe.

The above-described extrusion equipment is fairly complicated, most requiring multiple skilled operators. As a result, the equipment is housed in large coating facilities located remote from the actual pipeline installation sites, making the transportation of weighted concrete pipeline sections problematic and expensive. Damage to the coating is more likely if transport over great distances is needed. Transport also limits the length of pipeline sections that can be coated, since the weighted sections need to be accommodated on a truck bed or a railcar. As well, despite the existence of the patents indicating that multiple layers of concrete may be applied, in practice, the thickness of a concrete coating has been a limiting factor for pipeline weighting, with coatings exceeding a few inches being generally problematic.

There is thus a need for a simple concrete coating applicator that can apply multiple layers of concrete, with reinforcement such that a thick coating can be achieved. There is also a need for a mobile applicator that can be located proximate the pipeline pathway, and operated by a minimal work crew in a remote location.

### SUMMARY

In one broad aspect, there is provided a pipe coating apparatus which includes a concrete applicator station, a pipe conveyor adapted to longitudinally advance and axially rotate a section of pipe alongside the concrete applicator station; and an overhead container adapted to receive and dispense a supply of mixed concrete to the concrete applicator station. The concrete applicator station includes one or a plurality of concrete applicators, each concrete applicator being adapted to extrude a layer of concrete onto a carrier band, and to horizontally convey the layer of concrete on the carrier band to the underside of the pipe to form a continuous helical wrap of the layer of concrete on the carrier band around the pipe as the pipe is advanced and rotated, and in the case of the plurality of concrete applicators, each concrete applicator being laterally spaced one from another alongside the pipe such that the helical wrap from a first of the plurality of applicators is successively covered by the helical wrap from each of an adjacent of the plurality of concrete applicators.

In another broad aspect, there is provided a method of coating a section of pipe with a concrete coating. The method includes:
i. preparing a supply of mixed concrete and transferring the supply of mixed concrete to an overhead container of a concrete applicator station;
ii. conveying the section of pipe such that the pipe is longitudinally advanced and axially rotated alongside the concrete applicator station;
iii. extruding a first layer of concrete onto a first carrier band and horizontally conveying the first layer of concrete on the first carrier band to the underside of the pipe to form a continuous helical wrap of the first layer of concrete on the first carrier band around the pipe as the pipe is advanced and rotated; and
iv. optionally extruding a second layer of concrete onto a second carrier band which is laterally spaced and downstream from the first layer of concrete on the first carrier band, and horizontally conveying the second layer of concrete on the first carrier band to the underside of the pipe to form a continuous helical wrap of the second layer of concrete on the second carrier band over the first layer of concrete on the first carrier band; wherein:
v. the first carrier band is a non-woven geotextile in the case of only coating the pipe with the first layer of concrete on the first carrier band; and
vi. the first carrier band is a wire mesh and the second carrier band being a non-woven geotextile in the case of coating the pipe with both the first and second layers of concrete on the first and second carrier bands.

In yet another broad aspect, there is provided a method of coating a section of pipe with a concrete coating, comprising:
i. preparing a supply of mixed concrete and transferring the supply of mixed concrete to an overhead container of a concrete applicator station;
ii. conveying the section of pipe such that the pipe is longitudinally advanced and axially rotated alongside the concrete applicator station;
iii. extruding a first layer of concrete onto a first carrier band and horizontally conveying the first layer of concrete on the first carrier band on a first endless conveyor to the underside of the pipe to form a continuous helical wrap of the first layer of concrete on the first carrier band around the pipe as the pipe is advanced and rotated; and
iv. extruding a second layer of concrete onto a second carrier band and horizontally conveying the second layer of concrete on the second carrier band to the underside of the pipe on a second endless conveyor which is laterally spaced from, and downstream of the first endless conveyor to form a continuous helical wrap of the second layer of concrete on the second carrier band over the first layer of concrete on the first carrier band.

In yet another broad aspect, there is provided a method of coating a section of pipe with a concrete coating, comprising:
i. preparing a supply of mixed concrete and transferring the supply of mixed concrete to an overhead container of a concrete applicator station;
ii. conveying the section of pipe such that the pipe is longitudinally advanced and axially rotated alongside the concrete applicator station;
iii. extruding a first layer of concrete onto a first carrier band and horizontally conveying the first layer of concrete on the first carrier band to the underside of the pipe on a first endless conveyor which can be extended and retracted relative to the pipe to form a continuous helical wrap of the first layer of concrete on the first carrier band around the pipe as the pipe is advanced and rotated; and
iv. optionally extruding a second layer of concrete onto a second carrier band and horizontally conveying the second layer of concrete on the second carrier band to the underside of the pipe on a second endless conveyor which is laterally spaced from, and downstream of the first endless conveyor, and which can be extended and retracted relative to the pipe to form a continuous helical wrap of the second layer of concrete on the second carrier band over the first layer of concrete on the first carrier band.

In yet another broad aspect, there is provided a method of coating a section of pipe with a concrete coating, comprising:
i. preparing a supply of mixed concrete and transferring the supply of mixed concrete to an overhead container of a concrete applicator station;
ii. conveying the section of pipe such that the pipe is longitudinally advanced and axially rotated alongside the concrete applicator station;
iii. extruding a first layer of concrete onto a first carrier band and horizontally conveying the first layer of concrete on the first carrier band to the underside of the pipe on a first endless conveyor which can be adjusted in each of the vertical and horizontal planes to form a continuous helical wrap of the first layer of concrete on the first carrier band around the pipe as the pipe is advanced and rotated; and
iv. optionally extruding a second layer of concrete onto a second carrier band and horizontally conveying the second layer of concrete on the second carrier band to the underside of the pipe on a second endless conveyor which is laterally spaced from, and downstream of the first endless conveyor, and which can be adjusted in each of the vertical and horizontal planes to form a continuous helical wrap of the second layer of concrete on the second carrier band over the first layer of concrete on the first carrier band.

As used herein and in the claims, a reference to “longitudinal”, “front”, “rear”, “forwardly” etc. are terms meant to describe the pipe coating apparatus oriented alongside the longitudinal axis of the pipe, with “front”, “forward”, and “forwardly” being meant to refer to positions proximate to, or facing, the pipe, and with “rear” being meant to refer to positions more distal from the pipe.

As used herein and in the claims, a reference to “lateral” or “laterally” for spacing or position, refers to side-to-side spacing or position relative to front or rear as defined above.

As used herein and in the claims, the term “underside” when used relative to the pipe, is meant to describe a portion of the pipe which is ground-facing as it is rotated and coated.

As used herein and in the claims, the term “concrete” is meant to include a wide range of cementitious materials for either or both of weighting and protection purposes. Mixed concrete will include cement, aggregate (generally a coarse aggregate such as gravel, and a fine aggregate such as sand) and water. Other additives and components may be present, such as fibre reinforcing materials (glass, metal, carbon etc.), solidifying agents etc.

As used herein and in the claims, the term “geotextile” is meant to include both water permeable woven and water permeable non-woven geotextile materials. The non-woven geotextile material may be needle-punched or heat bonded. Generally the geotextile material will be formed from polypropylene, but other polymeric materials might be used. Most preferred as the outermost carrier band for the invention is a non-woven geotextile carrier band with a weight of 2-25 oz/yd², more preferably 3-5 oz/yd². Non-woven geotextile as a carrier band has been found to provide the following advantages or properties:
water permeable, so as not to interfere with the underlying anti-corrosion coatings.
air permeable, to allow for improved concrete setting.
concrete semi-permeable, allowing some of the extruded concrete to pass through the carrier band during application, partially embedding the carrier band near the outer surface of the coated pipe. This latter property provides extra concrete reinforcement and protection at the outer surface of the coated pipe.
the geotextile outer carrier band, unlike polywrap of the prior art, does not need to be removed from the coated pipe before installing the pipeline.

As used herein and in the claims, the term “pipe” is meant to include steel pipe, or pipe made from other rigid materials such as plastic and fibreglass. The pipe may be of varying diameters as used in pipeline installations. The pipe being coated may already include one or more protective coatings such as anti-corrosive coatings.

### BRIEF DESCRIPTION OF THE DRAWINGS

FIG. 1 is a front perspective view (partially schematic) of the pipe coating apparatus set up to coat a pipe (dotted outline), showing an operator, a generator, a concrete applicator station and a concrete mixing system, all mounted on a mobile truck trailer and positioned alongside a pipe conveyor system to support, rotate and advance a length of pipe to be coated.

FIG. 2 is a top perspective view of the concrete applicator station (other components removed) showing a carrier band being fed through each of three concrete applicators, to coat the pipe with three layers of concrete carried on the carrier bands.

FIG. 3A is a side sectional view through the concrete applicator station of FIG. 2, showing the path of one of the carrier bands through a concrete applicator relative to the overhead container, the concrete extruders and the conveyors.

FIG. 3B is an enlarged view of area B of FIG. 3, showing the detail of the apparatus at the rear of the concrete extruders.

FIG. 4 is a top perspective view of the concrete applicator system showing the frame support for the applicators at the front side of the trailer and a rear platform at the rear side of the trailer to allow an operator to maneuver at the rear of the concrete coating station and to carry feed rollers for one or more of the carrier bands.

FIG. 5 is a bottom perspective view of the concrete applicator system showing the hydraulic cylinders to advance and retract the conveyors for positioning at the underside of the pipe.

FIG. 6 is a top perspective view of the frame support for the applicators (conveyors removed), showing the overhead container for dispensing mixed concrete and showing the horizontal turntable mounts for the conveyors.

FIG. 7 is a top perspective view of a concrete extruder and compression roller, for placement on the conveyor.

FIG. 8 is a top perspective view of an extension frame for the conveyor assembly (conveyor belt removed) showing the conveyor belt support and extrusion shaping bars.

FIG. 9 is a bottom perspective view of the extension frame of FIG. 8.

FIG. 10 is a top perspective view of a conveyor support frame in which the extension frame can slide as the conveyors are extended and retracted to the pipe.

FIG. 11 is a bottom perspective view of the conveyor support frame of FIG. 10.

FIG. 12 is side view of a concrete applicator with a sides frame of the conveyor support frame removed to show details of the actuating cylinder and piston, and of the roller and roller track support for the extension frame.

FIG. 13 is a sectional view taken through line A-A of FIG. 12.

FIG. 14 is a schematic side sectional view of helical wraps being applied to a pipe surface in three successive layers

FIG. 15 is a schematic top view of the concrete applicators applying three layers of concrete to a pipe, with the first and second layers being carried on wire mesh carrier bands, and the third and final layer being carried on a geotextile material carrier band.

### DETAILED DESCRIPTION

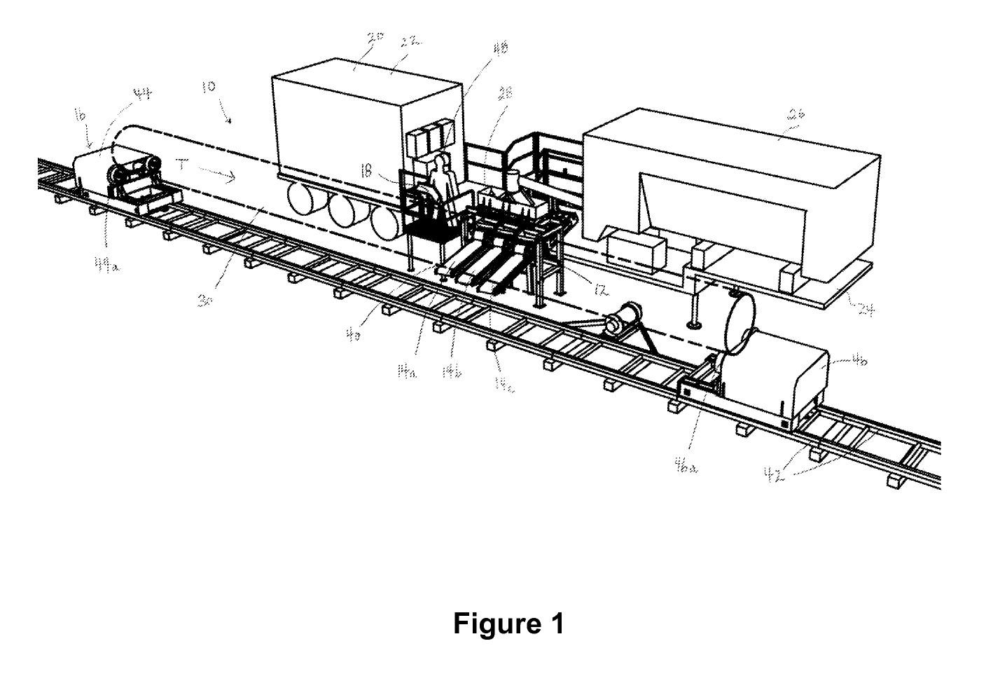

The pipeline coating apparatus is shown generally at 10 in FIG. 1 and preferably includes the following components:
concrete applicator station 12, including concrete applicators 14a, 14b, 14c;
pipe conveyor system 16 in front of concrete applicator station 12;
control system 18;
generator (power source, example diesel generator) 20, and fuel tank 22 (for remote locations);
mobile trailer 24 (example truck or rail mounted) supporting concrete applicator station 12; and
concrete mixing and delivery system 26, which may be trailer mounted or separate, for mixing and feeding mixed concrete into an overhead container 28 for gravity feed into the concrete applicator station 12.

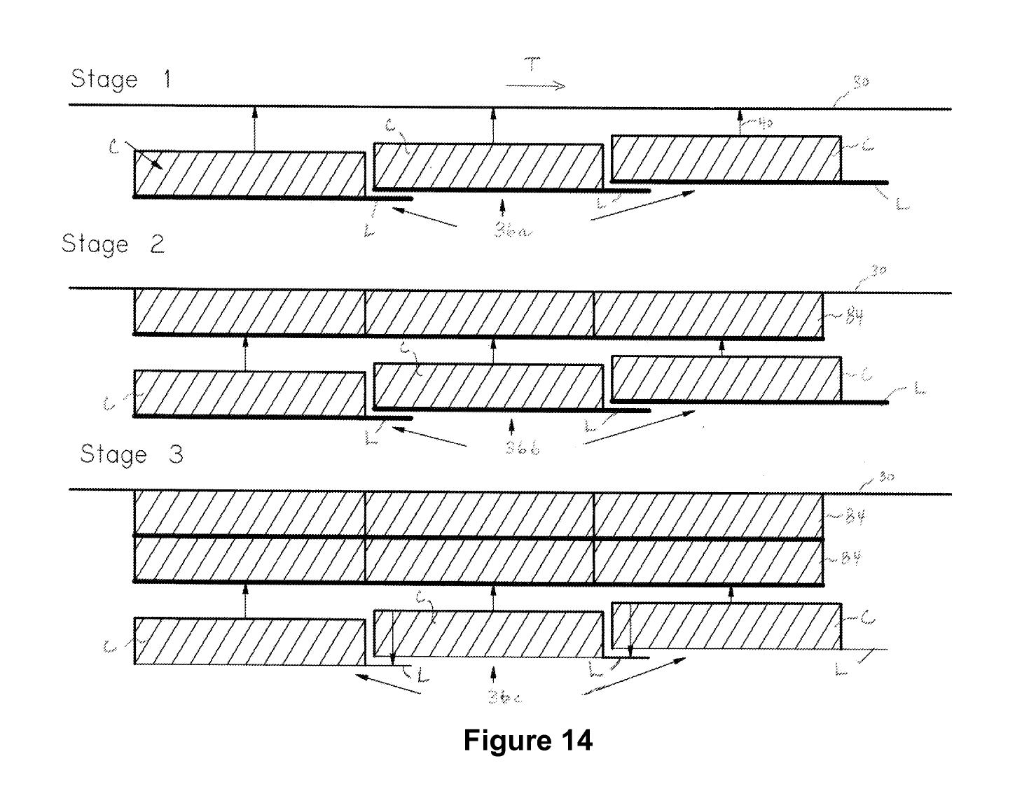

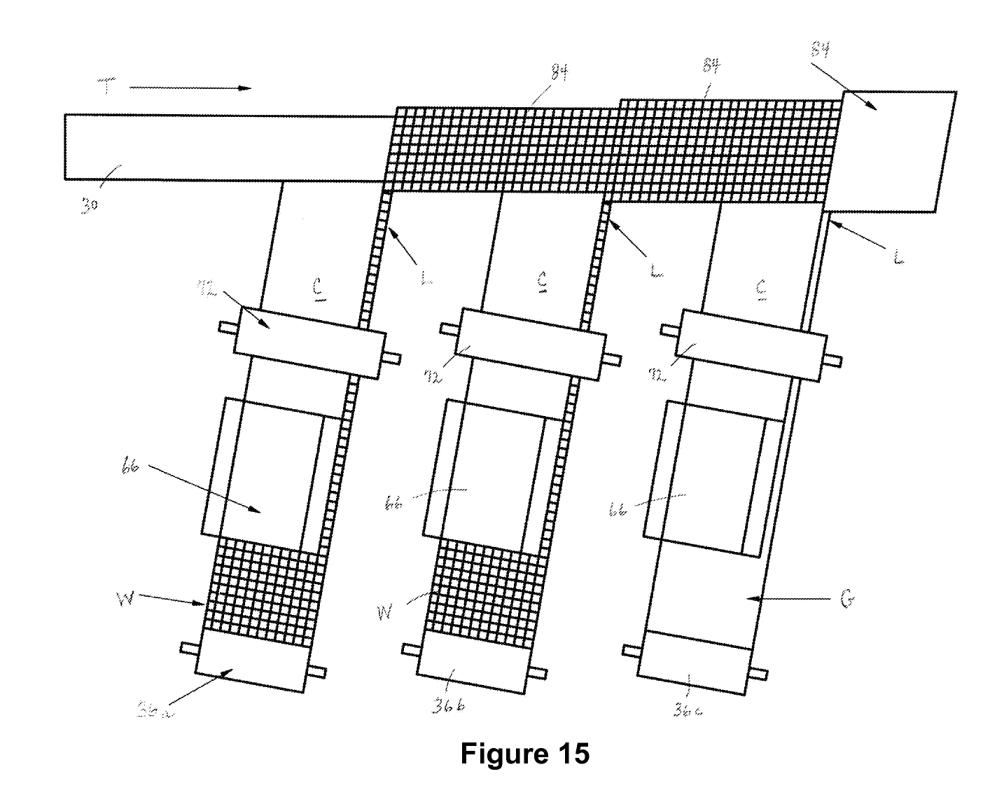

The pipeline coating apparatus 10 provides a compact set of equipment components designed to mechanically apply a concrete coating (C) in FIG. 14 as a continuous helical wrap of one or more layers (continuous concrete coating 84 in FIG. 15) onto a pipe 30. The apparatus 10 is able to achieve a concrete thickness between about ½ inches and 7½ inches onto a pipe 30. Typical pipe sizes for pipeline applications range from about 6 inches to 48 inches in diameter, but the pipeline coating apparatus is capable of handling other pipe sizes. The concrete coating is applied in several (typically 1, 2 or 3) separate and successive layers as required to reach the desired thickness. In the Figures three applicators 14a, 14b, 14c are shown, each able to provide one of the three layers. Like parts of each applicator are labeled with similar labels ending with a, b or c as appropriate. The entire apparatus 10 is preferably mobile trailer mounted so that it can to be moved from site to site and set up quickly and easily in even remote locations of pipeline installation.

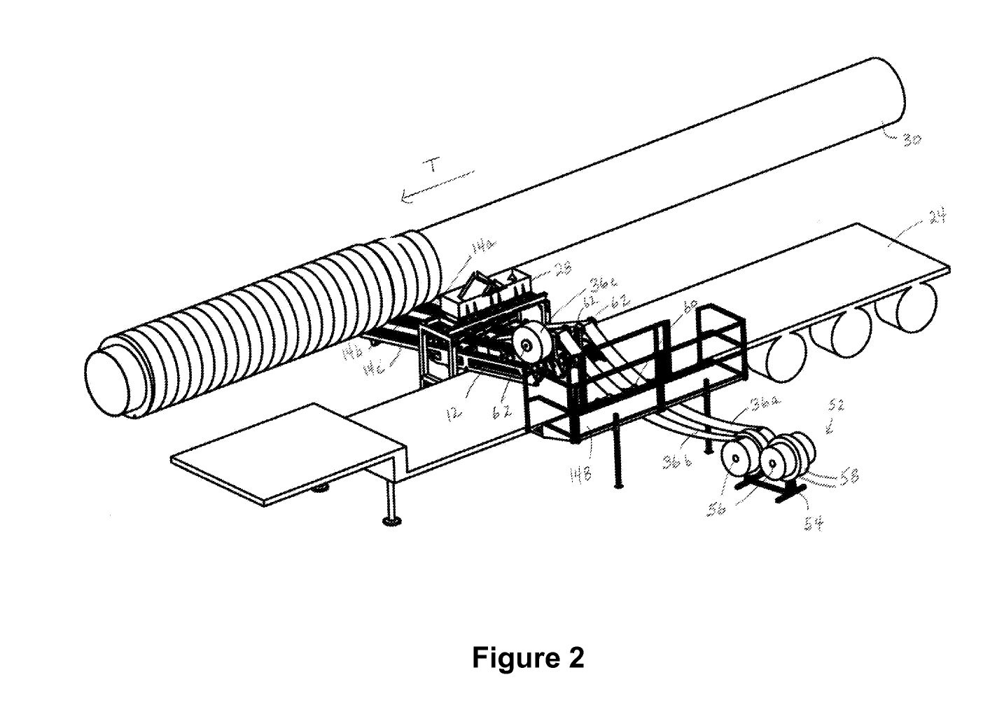

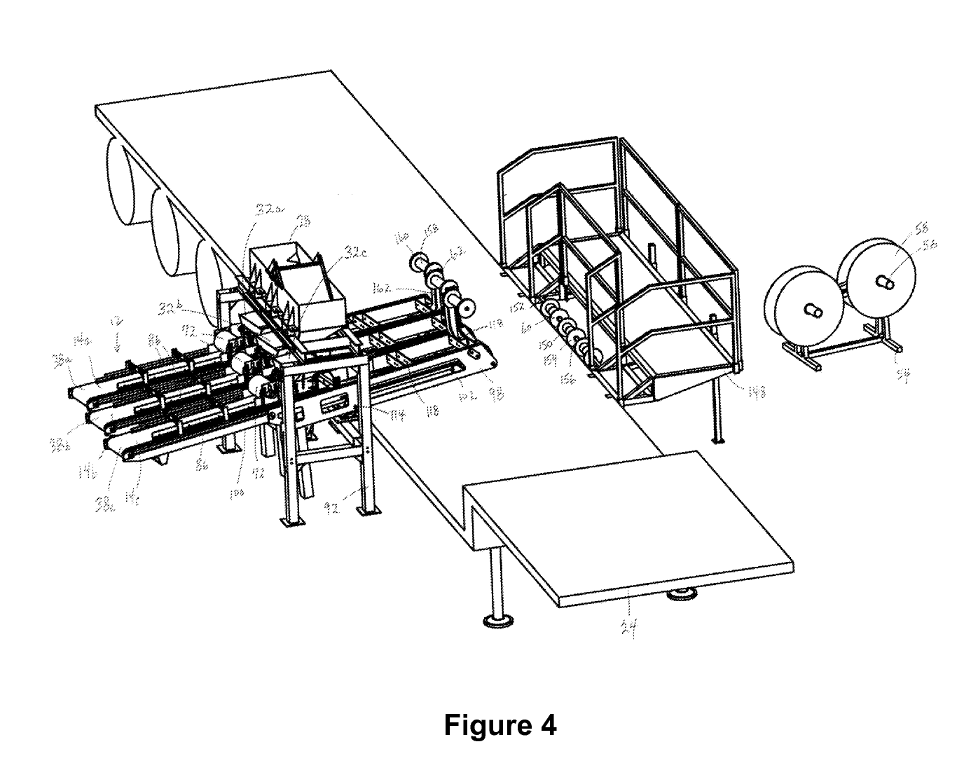

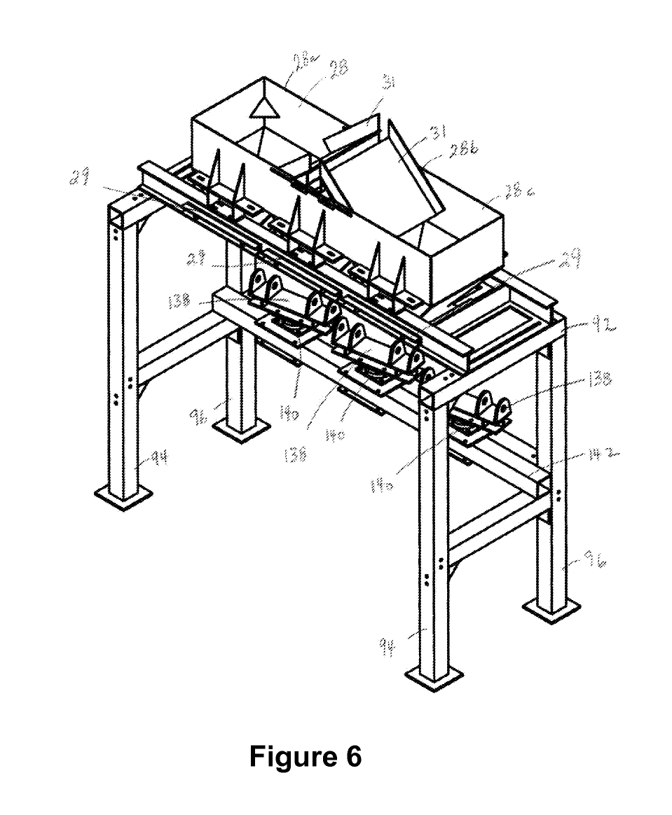

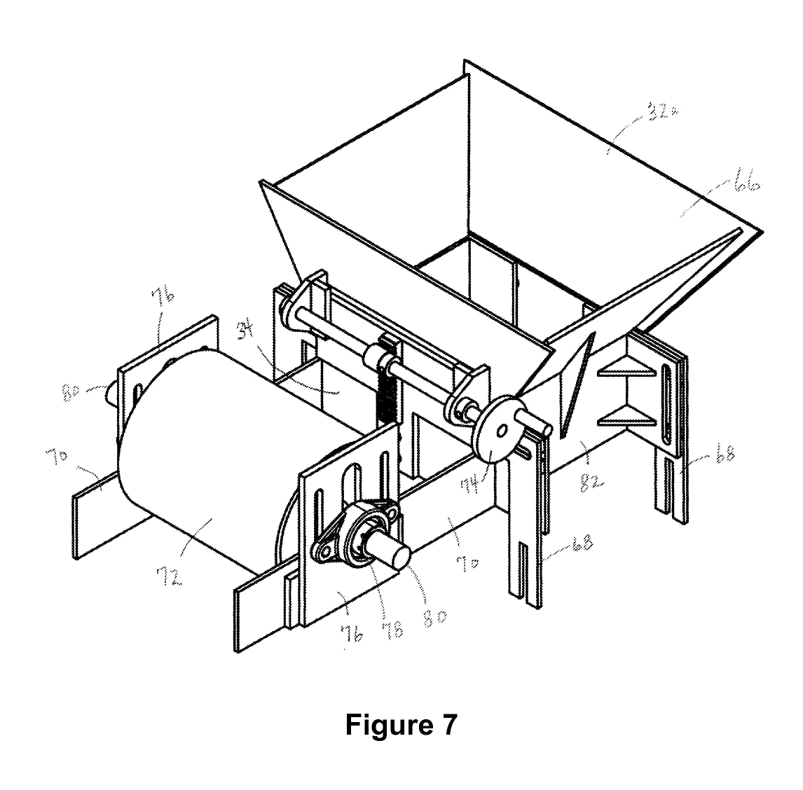

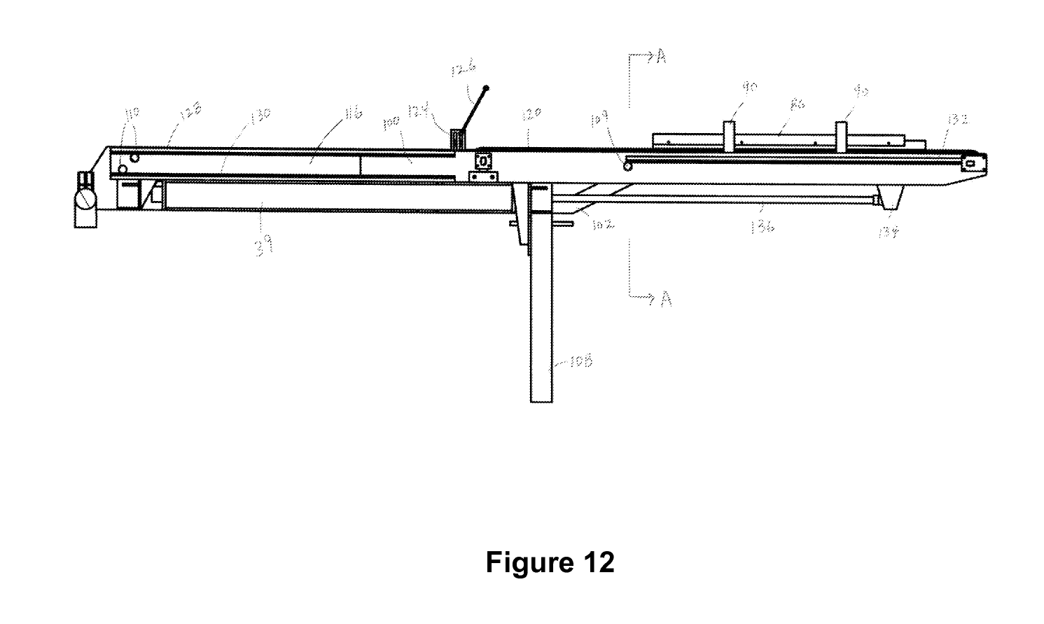

The overhead container 28 is adapted to receive and dispense (meter) mixed concrete, which is fed from the concrete mixing and delivery system 26. The container 28 is located above the concrete applicators 14a, 14b, 14c to gravity feed mixed concrete through adjustable gates 29 located at the bottom of the container 28, and into individual concrete extruders 32a, 32b, 32c (one for each applicator), best seen in FIGS. 4, 6 and 7. The overhead container 28 includes inclined and spaced concrete flow dividers 31 to split the concrete into three compartments 28a, 28b, 28c (see FIG. 6). The extruders 32a, 32b, 32c each have an independently adjustable gate 34 (see FIG. 7), to gravity dispense a controlled concrete flow, such that each extruder 32a, 32b, 32c extrudes a layer of concrete onto a carrier band 36a, 36b, 36c (see FIG. 2) being conveyed therebelow. In a three layer application of the Figures, the carrier bands 36a, 36b and 36c are typically arranged such that the first and second applicators 14a, 14b dispense onto wire mesh carrier bands 36a, 36c, while the third applicator 14c dispenses onto a geotextile carrier band 36c. Each applicator 14a, 14b, 14c is provided with a driven endless conveyor 38a, 38b, 38c (see FIG. 4) that travels below the concrete extruder 32b, 32b, 32c to support the layer of concrete on the carrier band 36a, 36b, 36c and to horizontally convey the layer of concrete on the carrier band 36a, 36b, 36c to the underside of the pipe 30. The conveyors 38a, 38b, 38c are adapted to be:
independently extended and retracted relative to the pipe 30, for example with actuating cylinders 39 (see FIG. 12) so as to adjust the position of the conveyor 38a, 38b, 38c at the underside of the pipe 30;
independently adjustable in a horizontal plane to adjust the angle of the conveyor 38a, 38b, 38c relative to the pipe 30 (i.e., relative to the longitudinal axis of pipe);
independently adjustable to pivot upwardly and downwardly to adjust a gap 40 (FIG. 14) between the endless conveyor 38a, 38b, 38c and the underside of the pipe 30 to accommodate a layer of concrete, different size pipes or different thicknesses of the layer of concrete;
positioned at an angle to the pipe 30 for a helical wrapping of each extruded layer, such that the helical wrap from each successive concrete applicator (ex. 14b, 14c) overlaps the helical wrap of the preceding concrete applicator (ex. 14a, 14b) to form a continuous concrete coating on the pipe 30; and
driven with independently variable speed control to adjust for an increasing diameter of coated pipe with successive helical wraps.

These features of the endless conveyors 38a, 38b, 38c allow the apparatus 10 to be adapted for different pipe sizes and different concrete layer thicknesses.

The pipe conveyor system 16 includes parallel rails 42 positioned in front of the concrete applicator station 12 and a pair of spaced apart wheeled vehicles 44, 46 configured to travel on the rails 42, and adapted to support the pipe 30 on pipe rollers 44a, 46a. The direction of travel of the pipe 30 is shown by arrow (T) on the longitudinal axis of the pipe 30 in FIG. 1. The first vehicle 44 is located upstream of the concrete applicator station 12 and is a powered vehicle adapted to advance and rotate the pipe 30. The speed of the first vehicle 44 is controlled and variable, such as with a variable speed pipe translation system using a closed loop type cable drive (not shown) that is separate from the vehicles 44, 46. As well, the first vehicle 44 includes a variable speed pipe rotation drive system (not shown) to vary the speed of pipe rotation. The second vehicle 46 is an idler vehicle located downstream of the concrete applicator station 12 to support the coated pipe for advanced movement along the rails 42, with a simple bearing/roller arrangement (not shown). The spacing between the vehicles 44, 46 is adjustable to accommodate different lengths of pipes. The pipe rollers 44a, 46a are adjustable, as is their rotation speed, to accommodate a large range of pipe diameters.

The control system 18 is preferably a dual mode control system having a first, set up mode which allows initial adjustments to be made to the conveyor positions, conveyor speeds, pipe rotation speed, pipe translation speed and concrete metering. Each of these set up positions and speeds will vary with different pipe sizes, layer thicknesses and other variables such as concrete setting times etc. A second run mode allows all drive elements to be started and stopped as needed. The control system 18 is preferably located as a control panel on the mobile trailer 24 at a position with line of sight by an operator 48 over the entire apparatus 10, such as shown in FIG. 1. The control system 18 includes independently adjustable controls for each of the power generator 20, the concrete mixing and delivery system 26, the advancing speed of the powered vehicle 44, the pipe rotating speed of the powered vehicle 44, the gates 29 of the overhead container 28, the actuating cylinders 39 used to extend and retract the conveyors 38a, 38b, 38c), and the speed of the rear driven conveyor rollers 50 for each of the conveyors 38a, 38b, 38c).

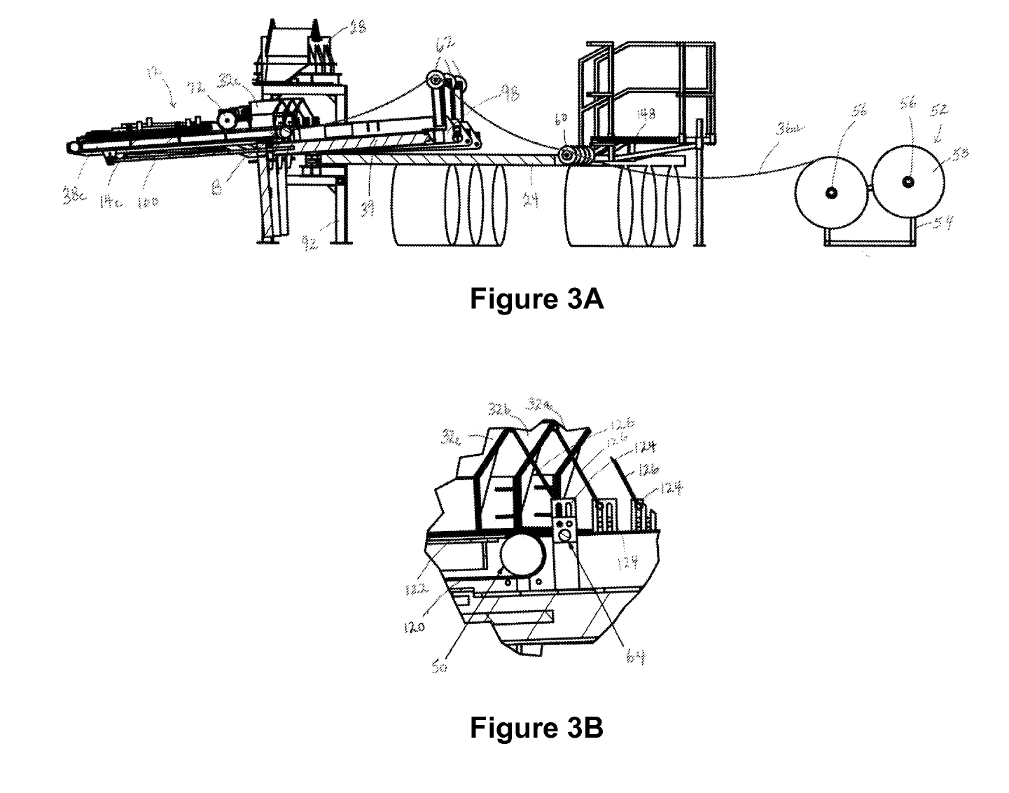

The carrier bands 36a, 36b, 36c are fed to the applicators 14a, 14b, 14c by a reel system 52. An example of a reel system 52 is shown in FIGS. 2, 3 to include a ground mounted reel frame 54 having spindles 56, each of which is adapted to hold one roll of a carrier band such as 36a, 36b (which may be reinforcing wire mesh). Each spindle 56 is backed by a backing plate 58 to support the roll of carrier band 36a, 36b. Each of the carrier bands 36a, 36b are threaded over a guide roller 60 to clear the rear of the trailer 24, over a guide roller 62 located at the rear of the conveyor 38a, 38b, 38c, and under a guide bar 64 located on the conveyor 38a, 38b, 38c proximate the driven roller 50 (see detail of FIG. 3A), so that the carrier band is fed under each of the extruders 32a, 32b, 32c. While all of the carrier bands 36a, 36b, 36c could be spindle mounted on reel frame 54 which is ground supported, the reel system 52 may also be mounted completely or partially on the trailer 24. For instance, in FIG. 2, the third carrier band 36c (for example geotextile material) is shown mounted on the guide roller 62. Each carrier band 36a, 36b, 36c extends along one of the conveyors 38a, 38b, 38c to the underside of the pipe 30, where it is pulled, so as to helically wrap the pipe 30 with the carrier band, as the pipe 30 is advanced and rotated. An operator may assist with the initial wrap, or the carrier band 36a, 36b, 36c may be initially connected to the pipe 30 for an initial wrap.

As best seen in FIG. 7, each of the concrete extruders 32a, 32b, 32c (labeled as 32 in FIG. 7), includes an open bottomed hopper 66 fixed with supporting slotted side brackets 68 for mounting above the endless conveyor 38a, 38b, 38c. The hopper 66 gravity feeds a layer of concrete onto one of the carrier bands 36a, 36b, 36c. An extrusion gate 34 at the front facing lower portion of the hopper 66 extrudes the layer of concrete from the hopper 66 onto the carrier band 36a, 36b, 36c being feed therebelow. The extruder 32 includes laterally spaced apart side bars 70 positioned in front of the extrusion gate 34 to shape the side edges of the extruded layer of concrete. A compression roller 72 is mounted between the side bars 70 to compress the extruded layer of concrete. The extrusion gate 34 is shown to be vertically adjustable at its front opening with a hand crank and ratchet device 74 to adjust the thickness of the extruded layer of concrete. This vertical adjustment mechanism may be controlled differently, for example with the control system 18 electronically opening and closing the gate 34. The compression roller 72 is also vertically adjustable (ex. roller side brackets 76 and clamping collars 78 on roller axle 80) to further adjust the degree of compression applied and thus the thickness of the layer of concrete. The hopper 66 and the side bars 70 are laterally adjustable (ex. adjustable side walls 82 on hopper 66, and adjustable lateral spacing of side bars 70, to vary the width of the extruded layer of concrete. As best seen in schematic FIGS. 14 and 15, the hopper 66 and side bars 70 are positioned over each of the conveyors 38a, 38b, 38c to feed the layer of concrete (C) onto the carrier band 36a, 36b, 36c such that a leading edge (L) of the carrier band 36a, 36b, 36c (relative to the direction of travel (T) of the pipe 30) remains uncoated by the concrete layer (C), to allow the uncoated leading edge (L) to overlap the helical wrap from the preceding concrete applicator to form the continuous concrete coating 84 on the pipe 30. In FIG. 15, carrier bands 36a and 36b are shown to be wire mesh (W), while carrier band 36c is shown as geotextile material (G). Thus, the finished appearance after the third layer shows as concrete coated geotextile. Each of the progressive three layers is shown as stage 1, stage 2 and stage 3 in FIG. 14, with each finished layer being shown as a continuous concrete coating 84.

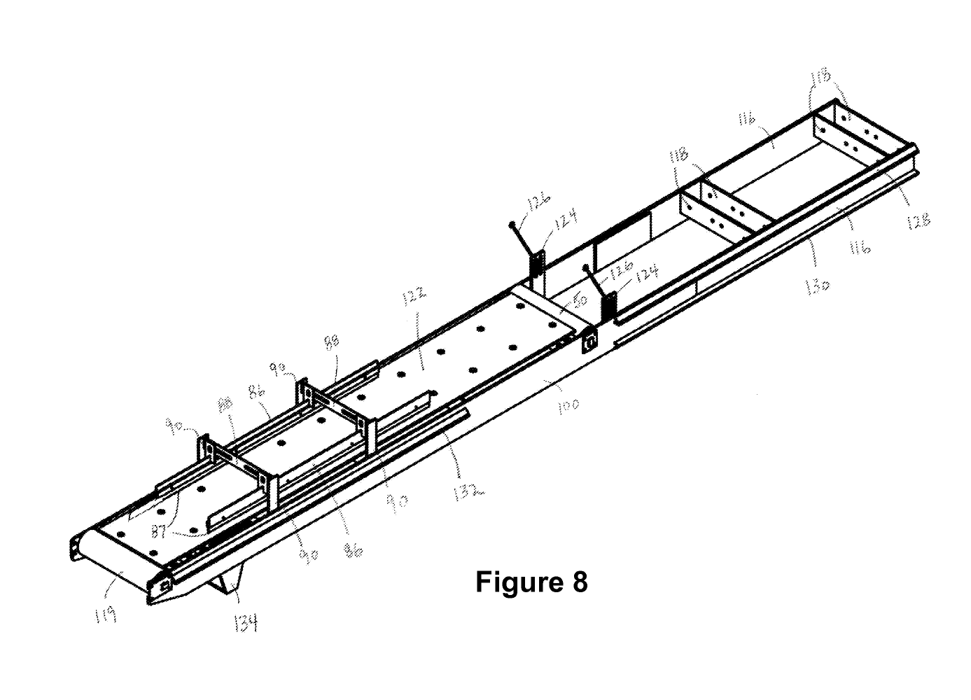

As best seen in FIGS. 4, 8 the apparatus may include laterally spaced apart extrusion shaping bars 86 mounted above one or more of the endless conveyors 38a, 38b, 38c, forwardly of the compression roller 72. The extrusion shaping bars 86 further shape the side edges of the extruded layer of concrete. The extrusion shaping bars 86 are width adjustable to vary the width of the extruded layer of concrete, and angle adjustable in a vertical plane to vary a bevel angle applied to the side edges of the extruded layer of concrete. In FIG. 8, this adjustability is provided by the lateral spacing of the shaping bars 86 on slotted cross members 88 mounted between shaping bar side brackets 90 connected to on each side of conveyors 38a, 38b, 38c.

One or more of the concrete extruders 32a, 32b, 32c, the side bars 70, and the extrusion shaping bars 86 may include wiper seals 87 (shown in the Figures on the extrusion shaping bars 86) along their lower edges to assist in containing and shaping the extruded layer of concrete along the conveyors 38a, 38b, 38c. The wiper seals 87 may be extended closer to the underside of the pipe 30 on one side of the conveyors 38a, 38b, 38c, than on the other side, as shown in FIGS. 4, 8 to better shape and contain the concrete as it is applied to the underside of the pipe 30.

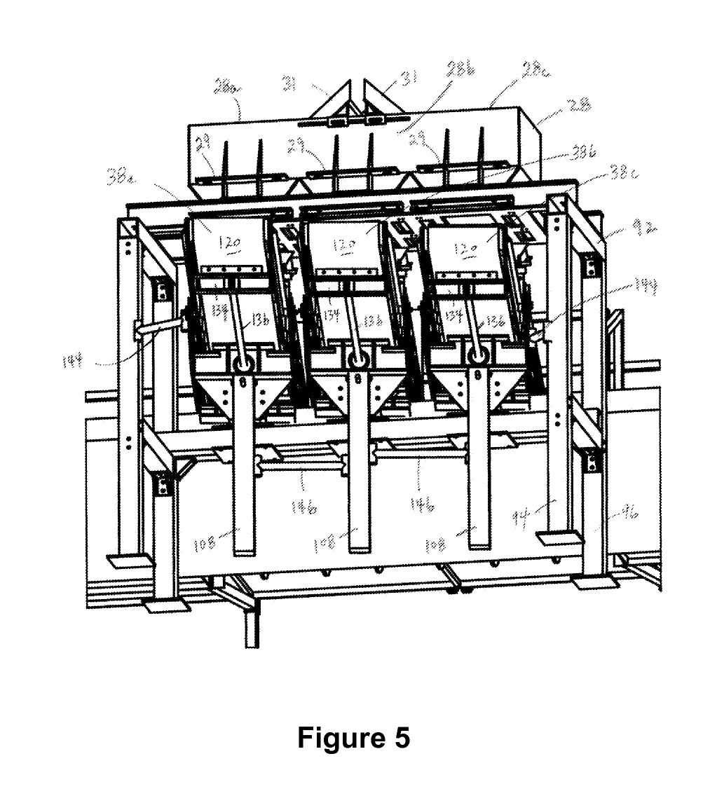

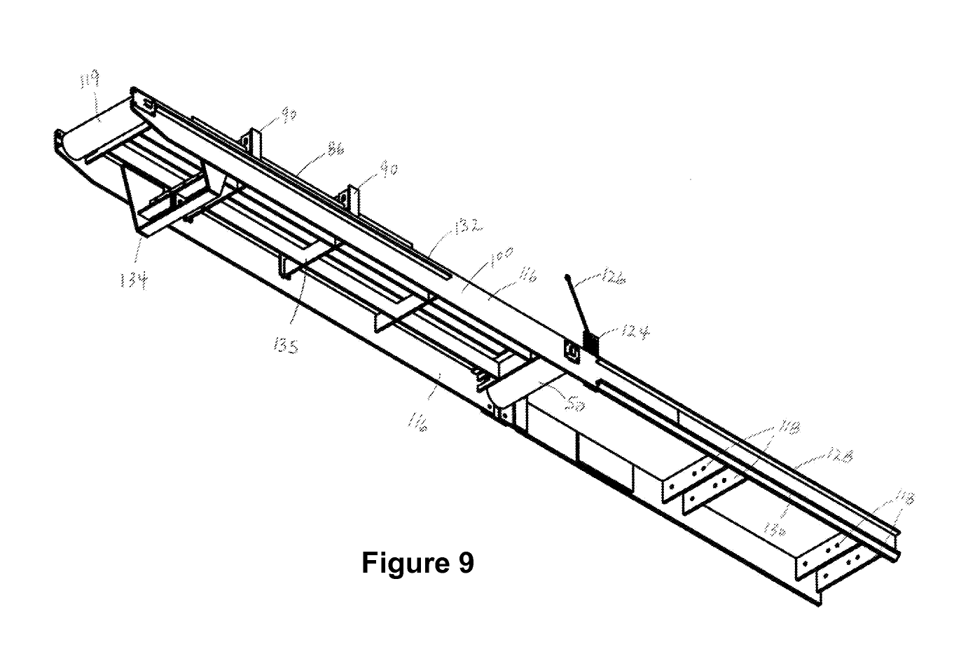

The details of the conveyors 38a, 38b, 38c are best shown in FIGS. 5, 6, and 8-13. The conveyors 38a, 38b, 38c may be trailer supported, frame supported and/or ground supported. In the Figures, each conveyor is shown to be horizontally supported at its rear portion by the trailer 24, and at its front portion by an applicator support frame 92. Frame 92 is ground supported on pairs of laterally spaced apart front legs 94 and rear legs 96 forward of the trailer 24, alongside the pipe conveyor system 16. The applicator support frame 92 is also shown to provide support for the overhead container 28.

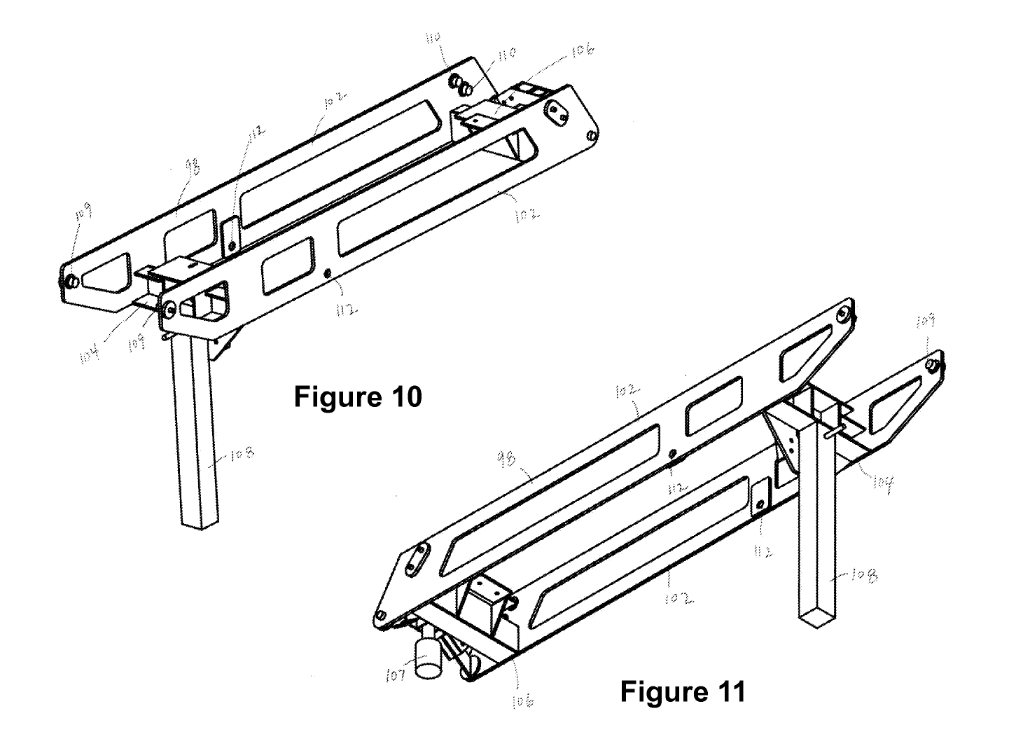

Each conveyor 38a, 38b, 38c is supported by a conveyor support frame 98, and includes a conveyor extension frame 100 positioned within the conveyor support frame 98. The extension frame 100 is adapted to slide within the conveyor support frame 98 between an extended position (to the underside of the pipe 30) and a retracted position (clear of the pipe 30). The conveyor support frame 98 includes parallel spaced side frames 102 connected by front and rear cross members 104, 106. The rear portion of the support frame 98 may include one or more height adjustable rear stabilizer legs 107 (see FIG. 11) to support and level the rear portion of the support frame 98 on the trailer 24. The front cross member includes a downwardly extending height adjustable stabilizer leg 108 for ground support. The front and rear cross members also provide mounts for the actuating cylinder 39. The front portion of the side frames 102 carries inwardly extending front support rollers 109 (two rollers 109, one on each side frame 102), while the rear portion of the side frames 102 carries inwardly projecting rear guide rollers 110 (four rollers 110, two upper and two lower on each side frame 102). The side frames 102 also include laterally spaced, aligned bracket holes 112 (see FIGS. 10, 11) for a cross shaft 114, to permit pivoting upwardly and downwardly of the conveyors 38a, 38b, 38c relative to the underside of the pipe 30. This vertical pivoting movement is typically achieved by locating the bracket holes 112 proximate the center of gravity of the assembled conveyor support frame 98 and the extension frame 100, and then locating this centre of gravity (axis of cross shaft 114) close to the front edge of the trailer 24 (as seen in FIG. 4). Other frame supporting systems may be used for the conveyors 38a, 38b, 38c. The components of the support frame 98 are typically formed from metal members such as steel, for strength.

The extension frame 100 includes parallel spaced apart side walls 116 adapted to fit within the conveyor support frame 98. The extension frame 100 may be supported within the conveyor support frame 98 by rails or roller tracks as described below. Alternatively, the extension frame may be self-supporting, or may be entirely supported by the trailer 24. The frame side walls 116 are connected together at their rear portions by several cross members 118, which may also serve to support the guide rollers 62 in one or more positions behind the extruders 32a, 32b, 32c. Also mounted between the side walls 116 are a front idler conveyor roller 119 and the rear driven conveyor roller 50. The rear driven roller 50 is located approximately in the middle section of the extension frame 100. A horizontal endless conveyor belt 120 extends around the front and rear rollers 119, 50. A solid rubber conveyor belt can be used, or any other type of belt capable of supporting a concrete layer (such as a perforated belt, or a slatted belt). A horizontal belt glide plate 122 such as low friction plastic or metal is also mounted between the side walls 116 to support the upper surface of the conveyor belt 120.

The slotted side brackets 68 (see FIG. 7) of the extruders 32a, 32b, 32c are adapted to slide over the frame side walls 116 at a location forward of the driven roller 50. Located rearwardly of the driven roller 50 on the frame side walls 116 are guide bar mounting brackets 124. As shown in the detail FIG. 3A, a guide bar 64 extends between these brackets 124, and each of the carrier band 36a, 36b, 36c is threaded under a guide bar 64 onto the conveyor belt 120, below the extruders 32a, 32b, 32c. These guide bar mounting brackets 124 also provide a convenient location for fastening a rear tension link such as a cable or chain 126 to the a rear location of the extruders 32a, 32b, 32c to prevent the extruders from tipping forwardly during concrete extrusion.

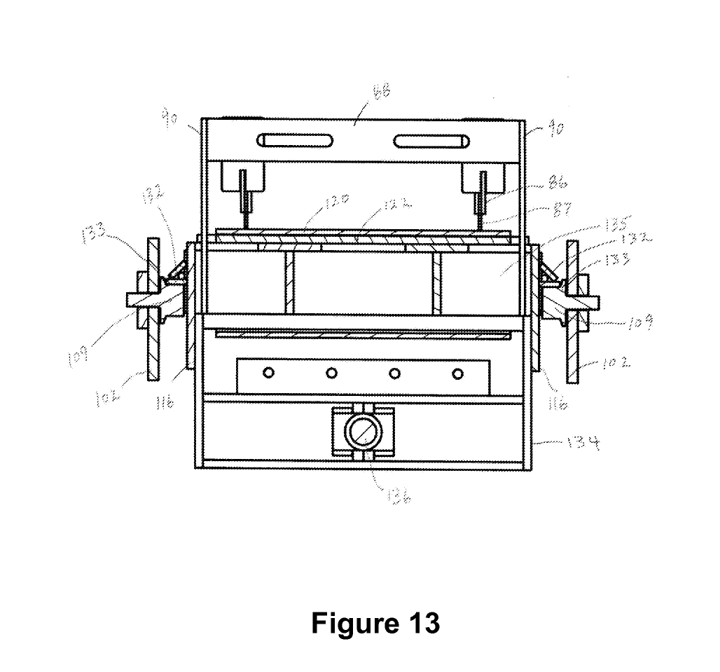

The extension frame 100 is supported within the conveyor support frame 98 by a number of rails or roller tracks 128, 130 and 132, which are supported on the rear and front rollers 110, 109 of the support frame 98. The rear portion of the extension frame 100 carries upper and lower roller tracks 128, 130 on the outer surface of the side walls 116 for rear guide rollers 110 of the conveyor support frame 98. The front portion of the extension frame 100 carries upper roller tracks 132 on the outer surface of the side walls 116 for front support rollers 109 of the conveyor support frame 98. As best seen in FIG. 13, the roller tracks 128, 130, 132 may be shaped as right angled triangular brackets extending from the side walls 116, and the rollers 109, 110 may be formed with side flanges 133 to keep the extension frame 100 centered within the support frame 98.

The underside of the extension frame 100 includes a cross member 134 for attaching the piston end 136 of the actuating cylinder 39. Additional cross frame members 135 may be included at the front portion of the extension frame 100 to support the glide plate 122 and the conveyor belt 120. In this manner, the actuating cylinder 39 is mounted between the conveyor support frame 98 and the front portion of the extension frame 100 such that the extension frame 100 can be extended and retracted. In the extended position, the front roller 119 is positioned at the underside of the pipe 30 for coating. The concrete extruders 32a, 32b, 32c, being supported by the extension frame 100, move with extension frame 100 to position the extruders 32a, 32b, 32c below the overhead container 28 in the extended position. As well, the extrusion shaping bars 86 are supported by the extension frame side walls 116 so as to be supported above the conveyor belt 120, forward of the extruders 32a, 32b, 32c. The components of the extension frame 100 are typically formed from metal such as steel for strength.

As best seen in FIGS. 4, 5 and 6, the applicator support frame 92 supports each of the conveyor support frames 98 for the endless conveyors 38a, 38b, 38c. The applicator support frame 92 providing a pivoting bracket support 138 for connection to each conveyor support frame 98. The bracket support 138 accepts the cross shaft 114 (see FIG. 4), extending between aligned bracket holes 112 in the spaced side frames 102 of the conveyor support frame 98. This provides a pivot point for upward/downward pivoting of each conveyor 38a, 38b, 38c such that the gap 40 at the underside of the pipe can be adjusted for each application (ex. different pipe sizes or concrete layer thicknesses). In set up mode, the pivot axis of cross shaft 114 permits the operator to adjust the height of the front stabilizer legs 108 and of the rear legs 107 of the conveyor support frame 98 for the desired gap 40 at the underside of the pipe 30. Generally, a pivoting movement through about a 20-30 range is desired. The bracket supports 138 are each mounted on a turntable 140, which in turn are supported by a horizontal cross member 142 of the applicator support frame 92. The turntables 140 include thrust bearings or other linkages to permit independent adjustment of the conveyors 38a, 38b, 38c in a horizontal plane. This adjusts the angle of the conveyors 38a, 38b, 38c relative to the longitudinal axis of the pipe 30.

The actuating cylinders 39 may take various forms, for example pneumatic or hydraulic cylinders.

Once the horizontal and vertical adjustments of the conveyors 38a, 38b, 38c are set for a particular application, the horizontal and vertical positions of the conveyors may be locked in place. FIG. 5 shows outer horizontal stabilizer bars 144 extending between the applicator support frame 92 and the conveyor support frames 98 of the outermost applicators 14a, 14c. For large pipe applications, additional inner horizontal stabilizer bars 146 may be mounted between the stabilizer legs 108 of the support frames 98, thus locking all of the applicators 14a, 14b, 14c together. These stabilizer bars 144, 146 may take the form of turnbuckles or other adjustable length bars with mounting adaptors at their ends for connection to the support frame 92 and the applicators 14a, 14b, 14c.

As seen in FIGS. 2-4, an elevated rear platform extension 148 may be included at the rear side of the trailer 24 to assist an operator to maneuver at the rear of the concrete applicator station 12. The rear platform 148 may be trailer and ground supported as shown. The guide rollers 60 for the carrier bands 36a, 36b, 36c may conveniently be carried beneath this platform 148. The guide rollers 60 may for example take the form of plastic cylindrical rollers 150 mounted on a roller shaft 152 and secured between plastic end plates 154 and shaft collars 156 (FIG. 4).

Guide rollers 62 may take the form of spindles 158 between end plates 160, mounted on a spindle support frame 162 extending upwardly from the cross members 118 of the conveyor extension frame 100.

All references mentioned in this specification are indicative of the level of skill in the art of this invention. All references are herein incorporated by reference in their entirety to the same extent as if each reference was specifically and individually indicated to be incorporated by reference. However, if any inconsistency arises between a cited reference and the present disclosure, the present disclosure takes precedence. Some references provided herein are incorporated by reference herein to provide details concerning the state of the art prior to the filing of this application, other references may be cited to provide additional or alternative device elements, additional or alternative materials, additional or alternative methods of analysis or application of the invention.

The terms and expressions used are, unless otherwise defined herein, used as terms of description and not limitation. There is no intention, in using such terms and expressions, of excluding equivalents of the features illustrated and described, it being recognized that the scope of the invention is defined and limited only by the claims which follow. Although the description herein contains many specifics, these should not be construed as limiting the scope of the invention, but as merely providing illustrations of some of the embodiments of the invention.

One of ordinary skill in the art will appreciate that elements and materials other than those specifically exemplified can be employed in the practice of the invention without resort to undue experimentation. All art-known functional equivalents, of any such elements and materials are intended to be included in this invention. The invention illustratively described herein suitably may be practiced in the absence of any element or elements, limitation or limitations which is not specifically disclosed herein.

As used herein, “comprising” is synonymous with “including,” “containing,” or “characterized by,” and is inclusive or open-ended and does not exclude additional, unrecited elements. The use of the indefinite article “a” in the claims before an element means that one or more of the elements is specified, but does not specifically exclude others of the elements being present, unless the contrary clearly requires that there be one and only one of the elements.

We claim:

1. A pipe coating apparatus comprising:
a concrete applicator station;
a pipe conveyor adapted to longitudinally advance in a direction of travel, and axially rotate, a section of pipe alongside the concrete applicator station;
an overhead container adapted to receive and dispense a supply of mixed concrete to the concrete applicator station; and
wherein the concrete applicator station comprises one or a plurality of concrete applicators, each concrete applicator being adapted to extrude a layer of concrete onto a carrier band, and to horizontally convey the layer of concrete on the carrier band to the underside of the pipe to form a continuous helical wrap of the layer of concrete on the carrier band around the pipe as the pipe is advanced and rotated, and in the case of the plurality of concrete applicators, each concrete applicator being laterally spaced one from another alongside the pipe such that the helical wrap from a first of the plurality of applicators is successively covered by the helical wrap from each of an adjacent of the plurality of concrete applicators.

2. The apparatus of claim 1, wherein each concrete applicator comprises:
a reel system adapted to feed the carrier band to the pipe so as to helically wrap the pipe with the carrier band as the pipe is advanced and rotated;
a concrete extruder adapted to extrude the layer of concrete onto the carrier band; and
an endless conveyor positioned below the concrete extruder to support the layer of concrete on the carrier band and to horizontally convey the layer of concrete on the carrier band to the underside of the pipe; and wherein
the overhead container is adapted to receive and dispense the supply of mixed concrete into the concrete extruder of each concrete applicator.

3. The apparatus of claim 2, wherein each endless conveyor is adapted to be independently extended and retracted to and from the pipe so as to adjust the position of the endless conveyor at the underside of the pipe.

4. The apparatus of claim 2, wherein each endless conveyor is adapted to be independently adjustable in a horizontal plane to adjust an angle of the endless conveyor relative to the pipe, and wherein each endless conveyor is adapted to be independently adjustable to pivot upwardly or downwardly to adjust a gap between the endless conveyor and the underside of the pipe.

5. The apparatus of claim 3, wherein each endless conveyor is adapted to be independently adjustable in a horizontal plane to adjust an angle of the endless conveyor relative to the pipe, and wherein each endless conveyor is adapted to be independently adjustable to pivot upwardly or downwardly to adjust a gap between the endless conveyor and the underside of the pipe.

6. The apparatus of claim 2, wherein at least one of the reel systems is adapted to feed a non-woven geotextile material as the carrier band.

7. The apparatus of claim 3, wherein at least one of the reel systems is adapted to feed a non-woven geotextile material as the carrier band.

8. The apparatus of claim 5, wherein at least one of the reel systems is adapted to feed a non-woven geotextile material as the carrier band.

9. The apparatus of claim 5, wherein:
the concrete applicator station includes the plurality of concrete applicators;
each endless conveyor is positioned at an angle to the pipe for the helical wrapping such that the helical wrap from each successive concrete applicator overlaps the helical wrap of the preceding concrete applicator to form a continuous concrete coating on the pipe; and
the reel system adapted to feed at least a first of the carrier bands to be applied is adapted to feed a wire mesh as the carrier band.

10. The apparatus of claim 9, wherein the reel system feeding a last of the carrier bands to be applied is adapted to feed a non-woven geotextile material as the carrier band.

11. The apparatus of claim 10, wherein each of the endless conveyors has an independently variable speed control to adjust for an increasing diameter of coated pipe with successive helical wraps.

12. The apparatus of claim 11, wherein each of the concrete extruders comprises:
an open bottomed hopper mounted above the endless conveyor adapted to gravity feed the layer of concrete onto the carrier band;
an extrusion gate at the lower portion of the hopper adapted to extrude the layer of concrete from the hopper onto the carrier band below the extruder;
laterally spaced apart side bars positioned in front of the extrusion gate to shape the side edges of the extruded layer of concrete; and
a compression roller mounted between the side bars to compress the extruded layer of concrete.

13. The apparatus of claim 12, wherein:
the extrusion gate is vertically adjustable to adjust the thickness of the extruded layer of concrete;
the hopper and side bars are adjustable to set the width of the extruded layer of concrete;
the hopper and side bars are positioned to feed the layer of concrete onto the carrier band such that a leading edge of the carrier band relative to the direction of travel of the pipe remains uncoated by the concrete to allow the uncoated leading edge to overlap the helical wrap of the preceding concrete applicator to form the continuous concrete coating on the pipe;
the compression roller is vertically adjustable to adjust the compressive force applied to the extruded layer of concrete; and
the apparatus further comprises laterally spaced apart extrusion shaping bars mounted above the endless conveyor to further shape the side edges of the extruded layer of concrete, the extrusion shaping bars being width adjustable to vary the width of the extruded layer of concrete, and angle adjustable to vary a bevel angle applied to the side edges of extruded layer of concrete.

14. The apparatus of claim 13, further comprising:
a conveyor support frame for each endless conveyor, each conveyor support frame being adapted to be independently adjustable in a horizontal plane to adjust the angle of the endless conveyor relative to the pipe, and independently adjustable to pivot upwardly or downwardly to adjust the gap between the endless conveyor and the underside of the pipe;
each endless conveyor comprising:
an extension frame positioned within the conveyor support frame being adapted to slide within the conveyor support frame between the extended and retracted positions;
a front and a rear conveyor roller mounted in spaced apart relationship on the extension frame such that the front roller, in the extended position, is positioned at the underside of the pipe, the rear roller being a driven roller and the front roller being an idler roller;
a horizontal endless conveyor belt extending around the front and rear rollers;
a belt glide plate mounted on the extension frame between the front and rear rollers to support the upper surface of the conveyor belt; and
an actuating cylinder mounted between a front portion of the extension frame and the conveyor support frame to extend and retract the extension frame between its extended and retracted positions; and wherein
each concrete extruder is supported by the extension frame above the endless conveyor belt, for movement with the extension frame to position the concrete extruder below the overhead container in the extended position, and the extrusion shaping bars are supported by the extension frame above the endless conveyor belt and forward of the concrete extruder.

15. The apparatus of claim 14, further comprising:
an applicator support frame to at least partially support each of the conveyor support frames, the applicator support frame providing a bracket support for connection to each conveyor support frame, each bracket support being mounted on a horizontal turntable to provide for adjustability for the endless conveyor in the horizontal plane, and each bracket support allowing the conveyor support frame to pivot upwardly and downwardly.

16. The apparatus of claim 15, wherein the applicator support frame supports the overhead container, and wherein the overhead container includes a plurality of independently adjustable gates, each adjustable gate being adapted to dispense the supply of mixed concrete into one of the concrete extruders.

17. The apparatus of claim 16, wherein each reel system includes a spindle to store one or more rolls of the carrier band, a guide bar positioned above the conveyor belt at the rear of the concrete extruder to guide the carrier band onto the conveyor belt below the guide bar, and optionally one or more guide rollers between the spindle and the guide bar to support the carrier band as it is fed from the spindle to the rotating pipe.

18. The apparatus of claim 17, wherein the pipe conveyor includes parallel rails positioned in front of the concrete applicator station, and a pair of spaced apart wheeled vehicles traveling on the parallel rails, one of the wheeled vehicles being located upstream of the concrete applicator station and being a powered vehicle adapted to advance and rotate the pipe, and the other of the wheeled vehicles being an idler vehicle located downstream of the concrete applicator station to support the coated pipe for advanced movement along the rails.

19. The apparatus of claim 18, further comprising:
a cement mixing and delivery system adapted to mix a supply of concrete and deliver the mixed concrete to the overhead container;
a power generator adapted to power the pipe conveyor, the cement mixing and delivery system, and the concrete applicators;
a mobile platform adapted to transport the concrete coating station, the applicator support frame, the cement mixing and delivery system, and the power generator, such that the mobile platform can be transported proximate a pipeline installation; and
independently adjustable controls for each of the power generator, the cement mixing and delivery system, the advancing speed of the powered vehicle, the pipe rotating speed of the powered vehicle, the gates of the overhead container, the actuating cylinders, and the driven rollers.

20. The apparatus of claim 19, wherein the mobile platform is adapted to support a rear portion of each conveyor support frame, with the applicator support frame being ground supported alongside the mobile platform supporting frame to support the front portion of each conveyor support frame.

21. The apparatus of claim 20, wherein the mobile platform is truck or rail mounted.

22. The apparatus of claim 21, wherein the independently adjustable controls are adapted to be operated from a control panel on the mobile platform.

23. A method of coating a section of pipe with a concrete coating, comprising:
preparing a supply of mixed concrete and transferring the supply of mixed concrete to an overhead container of a concrete applicator station;
conveying the section of pipe such that the pipe is longitudinally advanced and axially rotated alongside the concrete applicator station; and
extruding a first layer of concrete onto a first carrier band of a non-woven geotextile and horizontally conveying the first layer of concrete on the first carrier band to the underside of the pipe to form a continuous helical wrap of the first layer of concrete on the first carrier band around the pipe as the pipe is advanced and rotated.

24. A method of coating a section of pipe with a concrete coating, comprising:
preparing a supply of mixed concrete and transferring the supply of mixed concrete to an overhead container of a concrete applicator station;
conveying the section of pipe such that the pipe is longitudinally advanced and axially rotated alongside the concrete applicator station;
extruding a first layer of concrete onto a first carrier band of a wire mesh and horizontally conveying the first layer of concrete on the first carrier band to the underside of the pipe to form a continuous helical wrap of the first layer of concrete on the first carrier band around the pipe as the pipe is advanced and rotated; and
extruding a last layer of concrete onto a last carrier band of a non-woven geotextile which is laterally spaced and downstream from the first layer of concrete on the first carrier band, and horizontally conveying the second layer of concrete on the second carrier band to the underside of the pipe to form a continuous helical wrap of the second layer of concrete on the second carrier band over the first layer of concrete on the first carrier band.

25. A method of coating a section of pipe with a concrete coating, comprising:
preparing a supply of mixed concrete and transferring the supply of mixed concrete to an overhead container of a concrete applicator station;
conveying the section of pipe such that the pipe is longitudinally advanced and axially rotated alongside the concrete applicator station;
extruding a first layer of concrete onto a first carrier band and horizontally conveying the first layer of concrete on the first carrier band on a first endless conveyor to the underside of the pipe to form a continuous helical wrap of the first layer of concrete on the first carrier band around the pipe as the pipe is advanced and rotated; and
extruding a second layer of concrete onto a second carrier band and horizontally conveying the second layer of concrete on the second carrier band to the underside of the pipe on a second endless conveyor which is laterally spaced from, and downstream of the first endless conveyor to form a continuous helical wrap of the second layer of concrete on the second carrier band over the first layer of concrete on the first carrier band.

26. A method of coating a section of pipe with a concrete coating, comprising:
preparing a supply of mixed concrete and transferring the supply of mixed concrete to an overhead container of a concrete applicator station;
conveying the section of pipe such that the pipe is longitudinally advanced and axially rotated alongside the concrete applicator station; and
extruding a first layer of concrete onto a first carrier band and horizontally conveying the first layer of concrete on the first carrier band to the underside of the pipe on a first endless conveyor which can be extended and retracted relative to the pipe to form a continuous helical wrap of the first layer of concrete on the first carrier band around the pipe as the pipe is advanced and rotated.

27. The method of claim 26, which further comprises:
extruding a second layer of concrete onto a second carrier band and horizontally conveying the second layer of concrete on the second carrier band to the underside of the pipe on a second endless conveyor which is laterally spaced from, and downstream of the first endless conveyor, and which can be extended and retracted relative to the pipe to form a continuous helical wrap of the second layer of concrete on the second carrier band over the first layer of concrete on the first carrier band.

28. A method of coating a section of pipe with a concrete coating, comprising:
preparing a supply of mixed concrete and transferring the supply of mixed concrete to an overhead container of a concrete applicator station;
conveying the section of pipe such that the pipe is longitudinally advanced and axially rotated alongside the concrete applicator station; and
extruding a first layer of concrete onto a first carrier band and horizontally conveying the first layer of concrete on the first carrier band to the underside of the pipe on a first endless conveyor which can be adjusted in each of the vertical and horizontal planes to form a continuous helical wrap of the first layer of concrete on the first carrier band around the pipe as the pipe is advanced and rotated.

29. The method of claim 28, which further comprises:
extruding a second layer of concrete onto a second carrier band and horizontally conveying the second layer of concrete on the second carrier band to the underside of the pipe on a second endless conveyor which is laterally spaced from, and downstream of the first endless conveyor, and which can be adjusted in each of the vertical and horizontal planes to form a continuous helical wrap of the second layer of concrete on the second carrier band over the first layer of concrete on the first carrier band.
